(19) United States
(12) Patent Application Publication
(10) Pub. No.: US 2019/0200318 A1
(43) Pub. Date: Jun. 27, 2019

(54) SUPPORTING AN UPDATE OF STORED INFORMATION

(71) Applicant: Nokia Corporation, Espoo (FI)

(72) Inventors: Lauri Aarne Johannes WIROLA, Tampere (FI); Tommi Antero LAINE, Tampere (FI); Jari SYRJARINNE, TAMPERE (FI)

(73) Assignee: Nokia Corporation, Espoo (FI)

(21) Appl. No.: 14/384,354

(22) PCT Filed: Mar. 15, 2012
(86) PCT No.: PCT/IB2012/051226

§ 371 Date: Nov. 16, 2014

(51) Int. Cl. H04W 64/00; H04W 24/10; G01S 5/02

(52) U.S. Cl. CPC H04W 64/003; H04W 24/10; H04W 84/12; G01S 5/0242; G01S 5/0252; G01S 5/0263

(57) ABSTRACT

An apparatus receives information including data for a node of a communication network and an indication of a location for which the data is valid. The received information is evaluated in view of information that is stored for the node. The stored information may include data for the node and an indication of a mapping of the data to grid points of a grid, and each grid point may represent a particular location. The apparatus determines, in response to the evaluation, whether to use the received information for updating the stored information.

### FIELD OF THE DISCLOSURE

The invention relates to the field of storage of information, and more specifically to updates of stored information. The stored information may include data and an indication of a mapping of the data to grid points of a grid.

### BACKGROUND

Data may be stored with a mapping to grid points of a grid for instance in order to reflect the applicability of different pieces of data for different locations, while enabling at the same time a limitation of the total amount of data that has to be stored.

For example, modern global cellular and non-cellular positioning technologies are based on generating large global databases containing information on cellular and non-cellular signals. The information may originate entirely or partially from users of these positioning technologies.

The information provided by users is typically in the form of “fingerprints”, which contain a location that is estimated based on, e.g., received satellite signals of a global navigation satellite system (GNSS) and measurements taken from one or more radio interfaces for signals of a cellular and/or non-cellular terrestrial system. In the case of measurements on cellular signals, the results of the measurements may contain a global and/or local identification of the cellular network cells observed, their signal strengths and/or pathlosses and/or timing measurements like timing advance (TA) or round-trip time. For measurements on wireless local area network (WLAN) signals, as an example of signals of a non-cellular system, the results of the measurements may contain a basic service set identification (BSSID), like the medium access control (MAC) address of observed access points, the service set identifier (SSID) of the access points, and the signal strength of received signals (received signal strength indication RSSI or physical Rx level in dBm with a reference value of 1 mW, etc.).

This data may then be transferred to a server or cloud, where further models may be generated based on the data for positioning purposes. Such further models can be coverage area estimates or base station (BS) position and radio channel models. In the end, these refined radio models may be transferred back to user terminals for use in position determination.

The data received at a server has to be stored in order to be usable for refinement into further models or for any other purpose. It would be possible to store the measurement results and the associated locations as received. Alternatively, the received measurement results could be associated with grid points of a grid that represent locations close to the respective measuring position, in order to reduce the storage requirements.

### SUMMARY OF SOME EMBODIMENTS OF THE INVENTION

A method is described, which comprises at an apparatus receiving information including data for a node of a communication network and an indication of a location for which the data is valid. The method further comprises evaluating the received information at least in view of information that is stored for the node, the stored information including at least data for the node and an indication of a mapping of the data to grid points of a grid, and each grid point representing a particular location. The method further comprises determining, in response to the evaluation, whether to use the received information for updating the stored information.

Moreover a first apparatus is described, which comprises means for realizing the actions of the presented method.

The means of this apparatus can be implemented in hardware and/or software. They may comprise for instance a processor for executing computer program code for realizing the required functions, a memory storing the program code, or both. Alternatively, they could comprise for instance circuitry that is designed to realize the required functions, for instance implemented in a chipset or a chip, like an integrated circuit.

Moreover a second apparatus is described, which comprises at least one processor and at least one memory including computer program code, the at least one memory and the computer program code configured to, with the at least one processor, cause an apparatus at least to perform the actions of the presented method.

Moreover a non-transitory computer readable storage medium is described, in which computer program code is stored. The computer program code causes an apparatus to realize the actions of the presented method when executed by a processor.

The computer readable storage medium could be for example a disk or a memory or the like. The computer program code could be stored in the computer readable storage medium in the form of instructions encoding the computer-readable storage medium. The computer readable storage medium may be intended for taking part in the operation of a device, like an internal or external hard disk of a computer, or be intended for distribution of the program code, like an optical disc.

It is to be understood that also the computer program code by itself has to be considered an embodiment of the invention.

Moreover a system is described, which comprises any of the described apparatuses and a mobile terminal providing the measurement results.

Any of the described apparatuses may comprise only the indicated components or one or more additional components.

Any of the described apparatuses may be a module or a component for a device, for example a chip. Alternatively, any of the described apparatuses may be a device, for instance a server or a mobile terminal.

In one embodiment, the described method is an information providing method, and the described first apparatus is an information providing apparatus. In one embodiment, the means of the described first apparatus are processing means.

In certain embodiments of the described method, the method is a method for supporting an update of stored information. In certain embodiments of the described apparatuses, the apparatuses are apparatuses for supporting an update of stored information.

Further, it is to be understood that the presentation of the invention in this section is merely exemplary and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an apparatus according to an exemplary embodiment of the invention;

FIG. 2 is a flow chart illustrating a method according to an exemplary embodiment of the invention;

FIG. 3 is a schematic block diagram of a system according to an exemplary embodiment of the invention;

FIG. 4 is a flow chart illustrating an exemplary operation in the system of FIG. 3;

FIG. 5 is a diagram illustrating exemplary trajectories of two mobile stations;

FIG. 6 is a diagram illustrating errors resulting in an exemplary positioning operation when using an old database and an updated database;

FIG. 7 is a diagram illustrating the percentage of performed updates when using a threshold for deciding on a respective update;

FIG. 8 is a diagram comparing different types of updating;

FIG. 9 is a diagram illustrating the use of a covariance ellipse for deciding on an update; and

FIG. 10 is a diagram illustrating the use of a radio channel model for deciding on an update.

### DETAILED DESCRIPTION OF THE FIGURES

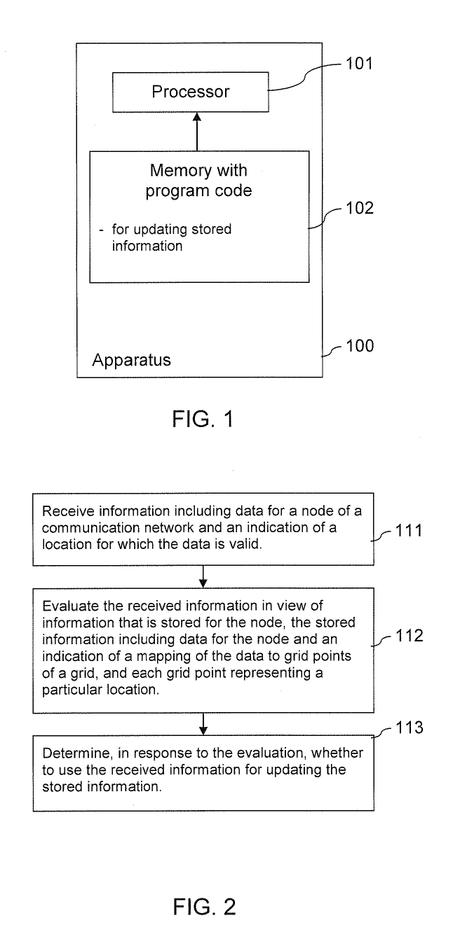

FIG. 1 is a schematic block diagram of an apparatus 100. Apparatus 100 comprises a processor 101 and, linked to processor 101, a memory 102. Memory 102 stores computer program code for supporting an update of stored information. Processor 101 is configured to execute computer program code stored in memory 102 in order to cause an apparatus to perform desired actions.

Apparatus 100 could be a server or any other device, for instance a mobile terminal. Apparatus 100 could equally be a module for a server or for any other device, like a chip, circuitry on a chip or a plug-in board. Apparatus 100 is an exemplary embodiment of any apparatus according to the invention. Optionally, apparatus 100 could have various other components, like a data interface, a user interface, a further memory, a further processor, etc.

An operation of apparatus 100 will now be described with reference to the flow chart of FIG. 2. The operation is an exemplary embodiment of a method according to the invention. Processor 101 and the program code stored in memory 102 cause an apparatus to perform the operation when the program code is retrieved from memory 102 and executed by processor 101. The apparatus that is caused to perform the operation can be apparatus 100 or some other apparatus, in particular a device comprising apparatus 100.

The apparatus receives information including at least data for a node of a communication network and an indication of a location for which the data is valid. (action 111)

The apparatus furthermore evaluates the received information at least in view of information that is stored for the node, the stored information including data for the node and an indication of a mapping of the data to grid points of a grid, and each grid point representing a particular location. (action 112)

The apparatus furthermore determines, in response to the evaluation, whether to use the received information for updating the stored information. (action 113) It is to be understood that the evaluation may optionally receive some further input. If it is decided not to use the received information for updating the stored information, the information may be discarded, provided to some further evaluation, or used for some other purpose.

The data for a node may not be static, but change over time. In order to take account of this, the data may be collected on a continuous or repetitive basis. However, with such a continuous or repetitive collection of data, the amount of received data may be rather high. Using all of the data for updating the stored data may thus cause a high processing load. This might result in performance problems, for instance with respect to database access. Furthermore, not all of the received data may be of the same value.

Some data that are received could be outliers that, if stored, might have a negative effect on the quality of the stored data.

Certain embodiments of the invention may thus enable an apparatus to support an evaluation of received information in view of stored information for deciding whether to update stored information using the receiving information.

Certain embodiments of the invention may have the effect that they allow calibrating stored data using new data to obtain and maintain a high quality of the stored data, while simultaneously limiting the number of updates.

Apparatus 100 illustrated in FIG. 1 and the operation illustrated in FIG. 2 may be implemented and refined in various ways.

The node of a communication network could be for instance a node of a cellular communication system, for instance a global system for mobile communications (GSM), a 3rd Generation Partnership Project (3GPP) based cellular system like a wide-band code division multiple access (WCDMA) system or a time division synchronous CDMA (TD-SCDMA) system, a 3GPP2 system like a CDMA2000 system, a long term evolution (LTE) or LTE-Advanced system, or any other type of cellular system, like a worldwide interoperability for microwave access (WiMAX) system. The node of a cellular communication system could be for instance a transceiver or a base station of the cellular communication system. In general, a node of a cellular communication system could be an entity serving exactly one cell, or an entity serving a plurality of cells from a single position. Alternatively, the node could be for example a node of a non-cellular communication system, like WLAN, Bluetooth and Zigbee, etc. The node of a WLAN could be a WLAN access point.

The received information may be provided for instance by mobile stations, for example by communication terminals, like mobile phones, smart phones, laptops, tablet computers, etc. The included data could comprise for instance the results of measurements on terrestrial radio signals from the nodes of a communication network determined or collected at the mobile stations at a respective location. Such measurement results could comprise for instance an indication of a received signal strength, like an RSSI or an Rx level value, an indication of a pathloss, an indication of a timing advance, an indication of a round-trip-time, etc.

Mobile terminals providing measurement results could provide at the same time an indication of their current position as the indication of the position for which the data is valid.

The received information can be evaluated in various ways in view of the stored information.

In a first exemplary approach, evaluating the received information comprises mapping the received data to a grid point of the grid taking account of the received indication of the position, and determining a difference between a value that is based on received data mapped to the grid point of the grid and a value that is based on stored data mapped to the same grid point of the grid. It may then be determined to update the stored information using the received information in the case that the determined difference exceeds a threshold value.

Evaluating the distance between new data and stored data for deciding on whether or not to update stored data may have the effect that only significant changes in the data may result in an update. If the received data and the stored data are very similar, the benefit of an update is limited and the processing power that would be needed for the update may be saved.

In the case that no data had been stored with a mapping to the grid point so far, other criteria may be considered for deciding on whether to use the received information for updating the stored information.

In an exemplary embodiment of the first approach, the threshold value is a fixed threshold value. In an alternative embodiment, the threshold value is a variable threshold value. Using a variable threshold value may have the effect that it enables a flexible adaptation to different situations. For example, a variable threshold value could take into account the amount of information that is currently received. For instance, whenever only little information is received, the threshold value could be set to a lower value to allow for more updates.

In an exemplary embodiment of the first approach, the value that is based on received data mapped to the grid point of the grid is a geometric mean of received data mapped to the grid point of the grid and of stored data mapped to the same grid point of the grid.

In an exemplary embodiment for the first approach or any other approach, stored data mapped to a grid point of a grid may be replaced for an update with a geometric mean of received data mapped to the grid point of the grid and of stored data mapped to the same grid point of the grid, in case it is determined to update the stored information using the received information. For instance, if the received data comprises a signal strength indication, the stored data may equally comprise a signal strength indication. However, from the first update onward, it may not correspond to any signal strength indication in received data, but rather be a repeatedly adapted signal strength indication.

Using a geometric mean between old data and new data for deciding on an update and/or for performing an update may have the effect that it may result in particularly accurate stored information. It is to be understood, however, that various alternatives to using a geometric mean could be used for both.

In a second exemplary approach, evaluating the received information comprises mapping the received data to a grid point of the grid taking account of the received indication of the position, determining a region based at least on information that is stored for the node, and determining whether the grid point to which the received data has been mapped lies within the region. It may then be determined to update the stored information using the received information in the case that the grid point to which the received data has been mapped lies within the region.

Determining whether a grid point to which newly received data has been mapped lies in a certain region may have the effect that outliers can be identified easily. On the one hand, this may improve the quality of the stored information, and on the other hand, processing power is saved if such outliers are not used for updating the stored data. The determined region could have for instance the form of an ellipse, but it could have any other form as well.

In an exemplary embodiment of the second approach, the region is a confidence region, which is determined statistically based at least on the grid points of the grid to which stored data for the node is mapped, optionally in addition based on the grid points to which the received data is mapped. Evaluating the received information based on the stored information statistically using a confidence region may have the effect that outliers can be identified with a desired reliability. In an exemplary embodiment, a confidence region is determined using a predetermined confidence that data mapped to grid points lying outside of the confidence region are outliers. In an exemplary embodiment, the confidence region is determined using a Chi-squared test. In an exemplary embodiment, the confidence area is an X-sigma covariance ellipse, where X is a fixed or variable value. Setting X allows adjusting the confidence at which measurement results are identified as outlier.

In other exemplary embodiments, the region is another kind of region than a confidence region. For instance, it could be determined as a region in which signals of the node can be expected to have a signal strength exceeding a certain threshold value in view of a radio channel model for the node that has been determined based on the stored information for the node.

It has to be noted that the same approach can be used alternatively or in addition for re-evaluating the validity of already stored information. In an exemplary embodiment, a region may be determined based on the information stored for the node and on the received information. In addition, it may be determined whether the stored information comprises data that is mapped to a grid point lying outside of the region. The result of the determination may then be used as at least one criterion for determining whether to remove data from the stored information.

For a third exemplary approach for evaluating the received information, it is assumed that the received data comprise a result of measurements on signals of the node. Evaluating the received information may then comprise determining a radio channel model for the node based at least on the stored information for the node, determining at least one measurement result that can be expected at the indicated position based on the radio channel model, and determining whether the received measurement result corresponds to the at least one determined expected measurement result or to a range defined by the at least one determined expected measurement result. It may then be determined to update the stored information using the received information in the case that the received measurement result corresponds to the at least one determined expected measurement result or the range defined by the at least one determined expected measurement result.

A radio channel model may comprise for instance the position of a node and a pathloss model for the signals transmitted by the node, or a plurality of pathloss models in the case of sectorized models. Alternatively, the radio channel model could only comprise one or more pathloss models, and the position of a node could be available as separate information. A pathloss model could be determined for instance based on pathloss values or signal strength values that are stored with a mapping to various grid points, and optionally in addition based on a currently received pathloss value or a currently received signal strength value that is mapped to a grid point.

Determining whether a measurement result in received information corresponds to a measurement result or a range of measurement results that can be expected in view of a radio channel model may have the effect that outliers can be identified easily. On the one hand, this may improve the quality of the stored information, and on the other hand, processing power is saved if such outliers are not used for updating the stored data.

A range of measurement results may be defined for example by an expected highest measurement result and an expected lowest measurement result, or by a single value and allowed deviations. A received measurement result may then correspond to a range defined by the at least determined expected measurement result if it lies between highest and lowest expected measurement result, or if it has a distance to a determined expected measurement result which lies within the allowed deviation, respectively.

For an exemplary variation of the third approach it is assumed as well that the received data comprise a result of measurements on signals of the node. In this variation, the following is performed in addition to any of the above presented evaluations of the received information. At least one measurement results that can be expected at the indicated position are determined based on a radio channel model for the node. Moreover, it is determined whether the received measurement result corresponds to the at least one determined expected measurement result or to a range defined by the at least one determined expected measurement result. It may then be determined to update the stored information using the received information in the case that the received measurement result corresponds to the at least one determined expected measurement results or to the range defined by the at least one determined expected measurement result.

This variation of the third approach may make use of radio channel models that are already available, or that are determined at some other apparatus. This approach could be used for supplementing any of the other presented embodiments. It is to be understood, however, that it could also be used by itself. Possible effects correspond to possible effects presented for the third approach.

It has to be noted that a similar approach as the presented third approach can be used alternatively or in addition for re-evaluating the validity of already stored information. Based on a radio channel model for a node, at least one result of measurements on signals of the node that can be expected at a position corresponding to a grid point to which stored data for the node is mapped may be determined, wherein the stored data mapped to the grid point comprise a stored result of measurements on signals of the node. Then, it may be determined whether the stored measurement result corresponds to the at least one determined expected measurement result or to a range defined by the at least one determined expected measurement result, and the result of this determination can be used as at least one criterion for determining whether to remove data from the stored information.

The radio channel model for a node could be determined for instance based on stored grid data for the node and on received information. This could have the effect that previously stored data can be re-evaluated in view of newly received data. Alternatively, the radio channel model for a node could be for instance a radio channel model that is received from an operator in the form of a position of the node and radio channel parameters. This could have the effect that stored data can be re-evaluated based on independent information. The re-evaluation of stored data could be used for supplementing any of the other presented embodiments. It is to be understood, however, that it could also be used by itself, that is, independently of the update of stored data using received data.

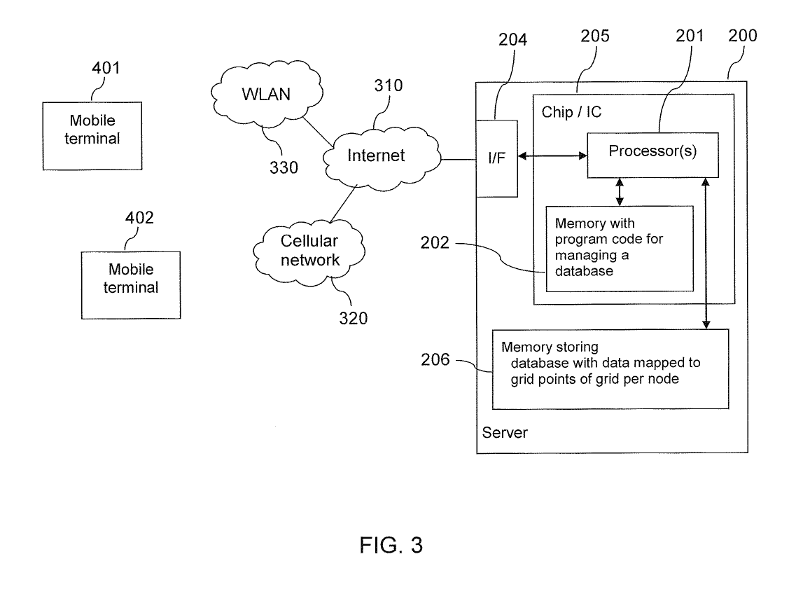

FIG. 3 is a schematic block diagram of a system enabling collection, storage and efficient update of data relating to nodes of one or more communication networks for supporting a positioning of mobile devices.

The system comprises a server 200. Server 200 is connected to a network 310, for example the Internet. Server 200 could also belong to network 310. Network 310 is suited to interconnect server 200 with mobile terminals 401, 402 via a cellular network 320 or via any of a plurality of WLANs 330.

Server 200 may provide or support a learning system for building up and updating a positioning data learning database, for instance a fingerprint database. Server 200 may be for instance a dedicated positioning server, a dedicated position data learning server, or some other kind of server. It comprises a processor 201 that is linked to a first memory 202, to a second memory 206 and to an interface (I/F) 204. Processor 201 is configured to execute computer program code, including computer program code stored in memory 202, in order to cause server 200 to perform desired actions.

Memory 202 stores computer program code for supporting an update of stored data. The computer program code may comprise for example at least similar program code as memory 102. The program code could belong for instance to a comprehensive application supporting a learning of position data and/or supporting a positioning of mobile terminals. In addition, memory 202 may store computer program code implemented to realize other functions, as well as any kind of other data. It is to be understood, though, that program code for any other actions than supporting an update of stored data could also be implemented on one or more other physical and/or virtual servers.

Processor 201 and memory 202 may optionally belong to a chip or an integrated circuit 205, which may comprise in addition various other components, for instance a further processor or memory.

Memory 206 stores at least one database that can be accessed by processor 201. The database is configured to store measurement data for nodes of cellular communication network 320 and of WLANs 330 with a mapping to grid points of a grid. For each node, at least one grid is defined. If a node of cellular communication network 320 serves several cells, at least one grid per cell may be defined for the node. The data may be stored with a mapping to grid points of a grid in various ways. Each grid could be represented for instance by a table that is stored in the database in memory 206, and measurement results and associated data could be inserted as an entry of the table. It is to be understood, however, that the storage of the data does not require storage of the entire grid or of a table corresponding to the entire grid. Since many grid points may not have any data associated with them so far, the data could be stored for instance efficiently using a run-length encoding in the database. Further alternatively, the indices of the grid points, with which data are associated, followed by the respectively associated data could be stored in a sequence in the database.

In addition, memory 206 could store other data, for instance other data supporting a positioning of mobile terminals. It is to be understood that the memory storing the database could also be external to server 200; it could be for instance on another physical or virtual server.

Interface 204 is a component which enables server 200 to communicate with other devices, like mobile terminals 401 and 402, via network 310. Interface 204 could comprise for instance a TCP/IP socket.

Component 205 or server 200 could correspond to exemplary embodiments of an apparatus according to the invention.

Cellular communication network 320 comprises a plurality of base stations operating as nodes of the network. Each WLAN 320 comprises at least one access point as a node of a communication network. Each of the nodes transmits signals that can be observed in certain associated area. In the case of cellular communication network 320, the area may comprise the areas of one or more cells.

Mobile terminals 401, 402 may comprise a GNSS receiver. Mobile terminals 401, 402 may further be configured to perform measurements on signals from nodes of cellular communication network 320 or WLANs 330, for example signal strength measurements. Further, they may be configured to report measurement results taken at different locations to server 200.

During an exemplary operation in the system of FIG. 3, mobile terminal 401 may receive satellite signals and determine its current position based on the satellite signals. In addition, mobile terminal 401 may detect signals transmitted by one or more nodes of cellular communication network 320. Mobile device 401 may assemble results of measurements on these signals, including for instance an indication of a received signal strength “Rx level”, in a report. It may further include in the report a direct or indirect identification of a respective node for which a measurement result is provided, for instance in the form of a global cell identity and/or a local cell identity. Alternatively or in addition, mobile terminal 401 may detect signals transmitted by access points (AP) of one or more WLANs 330, and include results of measurements on these signals in the report along with a respective identity of a WLAN AP. Mobile device 401 may then transmit the report along with an indication of the determined position as a fingerprint in a message to server 200. The transmission may take place via WLAN 330 and network 310 or via cellular network 320 and network 310. It has to be noted that in an alternative embodiment, the position of mobile device 401 could also be determined based on some other positioning technology than GNSS. For instance, if mobile terminal 401 collects only results of measurements on signals from cellular communication network 320, mobile terminal 401 could determine its position based on WLAN signals instead of GNSS signals.

Mobile terminal 401 may transmit similar messages from various locations to server 200 while moving around. In addition, other mobile terminals, for instance mobile terminal 402, may transmit corresponding messages to server 200.

Having a large number of data collection clients in the field guarantees that there is a sufficient data inflow at server 200 for enabling a continuous calibration of the grids in memory 206 and for keeping the data up-to-date for the best end-user positioning performance. The implementation of server 200 limits the risk that the number of database updates becomes so big that the updates cause a bottleneck with respect to processing load and/or access to memory 206.

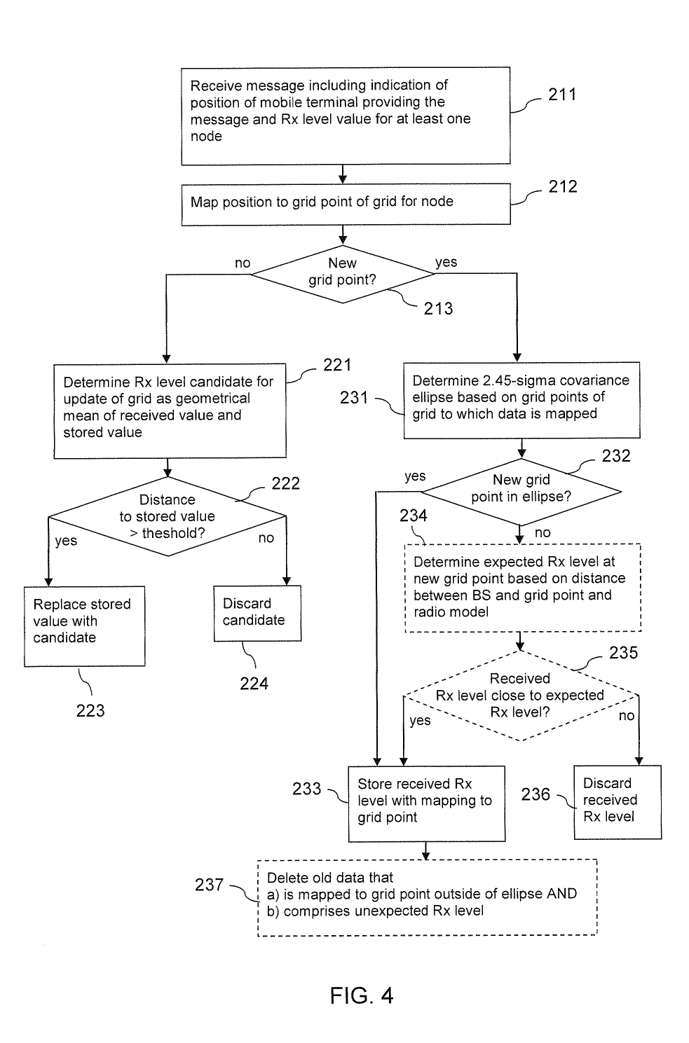

An exemplary operation at server 200 of the system of FIG. 3 will now be described with reference to the flow chart of FIG. 4. Processor 201 and the program code stored in memory 202 cause server 200 to perform the presented operations when the program code is retrieved from memory 202 and executed by processor 201.

Server 200 receives from mobile terminal 401 a message with an Rx level value for at least one node of a communication network 320, 330 and an indication of a position of mobile terminal 401. (action 211) Signal strength values from cellular and non-cellular nodes could be for example in the range −140 to −20 dBm. Alternatively or in addition to Rx level data, the message could comprise any other kind of data, in particular any other kind of data relating to areas served by nodes of a communication network.

Server 200 identifies at least one node for which an Rx level value is included in the message and selects a grid associated to the node. Server 200 further determines the grid point of the grid, which represents a location that is closest to the position indicated in the message. (action 212) It is to be understood that this also comprises a case in which server 200 identifies at least one cell for which an Rx level value is included in the message and maps the indicated position to a grid point of a grid that is associated to the cell, since with the identification of a cell also the node serving the cell is identified.

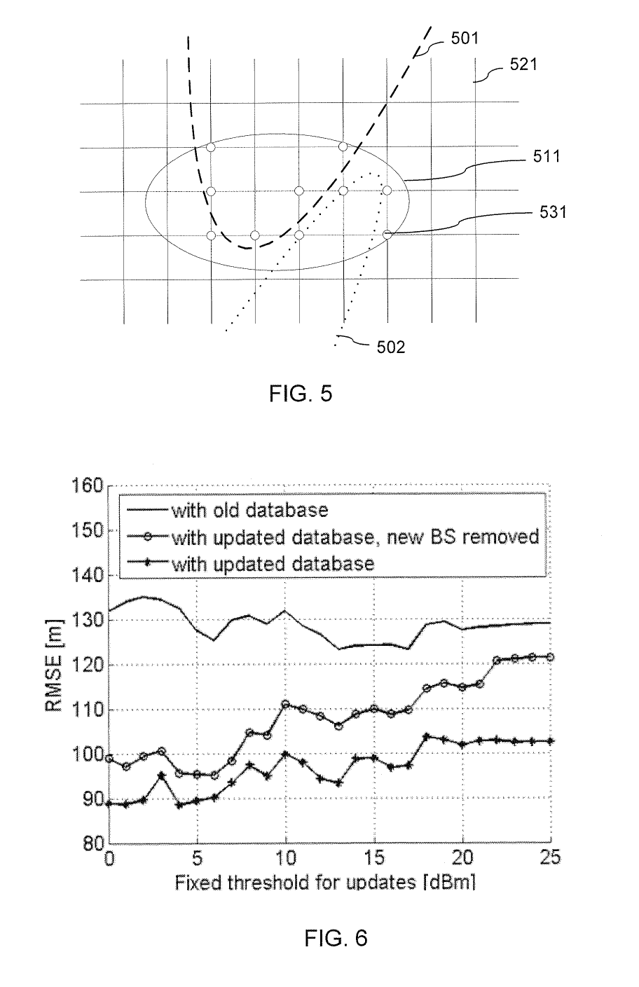

FIG. 5 is a diagram illustrating the mapping. FIG. 5 shows exemplary trajectories of two mobile terminals 401, 402, one indicated with a dashed line 501 and the other indicated with a dotted line 502. While the terminals 401, 402 are located in an observable area 511 of a cell served by a particular node, the terminals 401, 402 provide results of measurements on signals from this node and an indication of the position at the respective time of measurement to server 200. The observable area 511 of the cell is covered by a grid 521, and the positions indicated for a respective measurement result are mapped to grid points of the grid. The grid points that may be selected for indicated positions on trajectories 501 and 502 are pointed out with small circles 531 in FIG. 5. Since the observable areas of several nodes may be overlapping, a terminal located in observable area 511 may also provide results of measurements on signals from one or more other nodes at various positions.

If the grid point to which the indicated position is mapped is a grid point for which an Rx level value had already been stored before in the database in memory 206 (action 213), server 200 determines an “Rx level candidate” for updating the grid, if appropriate (action 221).

The “Rx level candidate” is a value in dBm that is determined as the geometric mean of the Rx level value “Stored Rx level value for grid point” that is currently stored with a mapping to the determined grid point and the Rx level value “New Rx level value” in the received message. The “Rx level candidate” can be determined according to the following equation:

$$Rx level candidate = \sqrt{\vert Stored Rx level value for gridpoint \vert \cdot \vert New Rx level value \vert}$$

Server 200 then determines whether the distance of this “Rx level candidate” to the previously stored value “Stored Rx level value for grid point” exceeds a predetermined threshold value α, checking for instance the following equation (action 222):

|Stored Rx level value for gridpoint−Rx level candidate|≥α

If this equation is true, the value “Rx level candidate” is used to replace the previously stored Rx level value for the grid point. (action 223)

If the equation is not true, the value “Rx level candidate” and the received “New Rx level value” are discarded at least with respect to the update of the grid. (action 224)

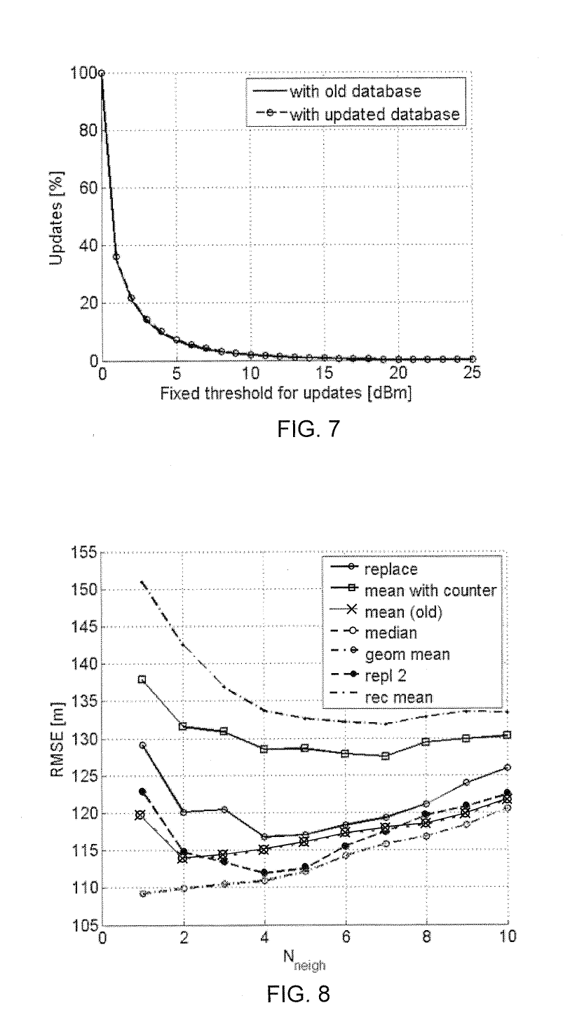

FIGS. 6 and 7 are diagrams illustrating the effect of the use of a threshold value on the update in a test case.

At first, a first set of data A was collected in a test area to generate individual Rx level grids for different nodes in the test area. Later on, two further sets of data B and C were collected in the same test area. Data set C was collected specifically for updating the grid. Data set B was collected specifically for testing the performance of a positioning using a conventional fingerprinting. Sets of data B and C originate from a similar period of time, but both have a temporal separation compared to set of data A.

FIG. 6 illustrates a root-mean-square error (RMSE) in meters that resulted in the positioning with different fixed update threshold values in dBm using different databases. The threshold value was the value that had to be exceeded by the difference between the geometrical mean of a new value and a stored value on the one hand and the stored value on the other hand when generating/updating the grid data, as described with reference to actions 221 and 222 of FIG. 4.

The upper solid line in FIG. 6 shows the positioning error that resulted with stored data that was based on set of data A only. The database storing these data is referred to as “old database” in FIG. 6. The data was collected over a certain period of time and updated within this time using the indicated fixed threshold values. The RMSE had a value of approximately 130 m with all threshold values. It is to be understood that this first set of data A could also have been collected and mapped without updating. In this case, there would have been a single RMSE value of approximately 130 m.

The lowest line marked with asterisks in FIG. 6 shows the positioning error that resulted when the original set of data A was updated with set of data C using the indicated fixed threshold values. The corresponding database is referred to as “updated database” in FIG. 6. It can be seen that the error reduced with decreasing threshold value, but essentially only below a value of 7 dBm.

In the test case, signals of a new base station were detected when collecting the set of data C. Information on additional nodes is likely to improve positioning performance. Therefore, an additional line marked with small circles in FIG. 6 shows the positioning errors that resulted when omitting the measurement results of this new base station in order to make the RMSE values comparable to the RMSE values that resulted with set of data A. The corresponding database is referred to as “updated database, new BS removed” in FIG. 6. The course of the line is comparable to the line with asterisks, just somewhat higher, but significantly lower than the line resulting with the database that was based only on set of data A.

Thus, there were dynamic effects in the Rx levels within the node coverage area. Such effects may be, for instance, due to seasons, since leaves in the trees may affect the Rx levels. Also the landscape may change over time, because new buildings may be build, which also affects the Rx levels in the area.

FIG. 7 is a diagram illustrating for the test case the performed updates as a percentage of the number of received measurements that had to be carried out when using different fixed threshold values in dBm for the update. The updates are shown for both the generation of the grid data based only on set of data A, and for grid data when updated with the set of data C. Both resulted in essentially the same curve. It can be seen that the amount of updates decreased significantly when increasing the fixed threshold value from 0 dBm, meaning that 100% of the received measurement results were used for an update, to 5 dBm, where only about 8% of the received measurement results had to be used for the update.

Summarized, the test case showed that the positioning improved with an updated database, and that low threshold values greater zero are suited to decrease the required number of updates significantly without causing a degradation of the quality of positioning.

FIG. 8 is a diagram illustrating the effect of the used replacement method in the update on the quality of a positioning in a further test case. For the test case a grid size of 50 m*50 m was used, and 9601 measurements were performed for generating and updating a test database with different replacement methods.

The diagram shows the RMSE in meters resulting in a positioning when using databases updated with different replacement methods. The errors are shown for different numbers of considered neighbors N_{neigh} in a conventional N-nearest neighbors fingerprinting approach. In an N-nearest neighbors approach, for instance the Rx levels for different nodes provided in a fingerprint of a mobile terminal that is to be positioned may be compared to stored Rx levels for corresponding nodes, considering all or selected grid points of a grid for each node. For instance, the minimum Euclidean distance between the Rx levels in the received fingerprint and the Rx levels for a particular grid point in different grids could indicate this particular grid point to be the nearest neighbor. The N grid points resulting in the N smallest

Euclidean distances may be selected as N nearest neighbors. The position associated to the N nearest neighbors may be combined in a suitable manner, using for instance a weighted average, for determining the position of the mobile terminal.

In FIG. 8, the solid line with circles (“replace”) indicates the RMSE that resulted with an approach, in which new measurement results replaced the respective old grid point value without further consideration.

The solid line with squares (“mean with counter”) in FIG. 8 indicates the RMSE that resulted with an approach, in which the respective true arithmetic mean over the whole history was used for replacing the respective old grid point value. For enabling a continuous determination of a new mean value, the current mean and the number of samples used so far to calculate the mean was kept in the storage. The mean update was performed as follows: Values u (mean) and k (counter) were stored. In case of an incoming sample Rx, a respective new mean value was determined as u:=(k*u+Rx)/(k+1), a new counter value was determined as k:=k+1, and both values were stored.

The solid line with asterisks (“mean (old)”) in FIG. 8 indicates the RMSE that resulted with an approach, in which the arithmetic mean of the current grid point value and the new sample was stored as the respective updated grid point value.

The dashed line with circles (“median”) in FIG. 8 indicates the RMSE that resulted with an approach, in which the median of the current grid point value and the new sample were stored as respective updated grid point value. Note that this line coincides with the line for “mean (old)”.

The dash-dotted line with circles (“geom mean”) in FIG. 8 indicates the RMSE that resulted with an approach in which the geometric mean of the current grid point value and the new sample was used for replacing a respective grid point value. This corresponds to the approach described with reference to actions 221 and 223.

The dashed line with black circles (“replace 2”) in FIG. 8 indicates the RMSE that resulted with an approach in which the new sample replaced the stored grid point value, but only in case the new sample had higher value than the stored grid point value.

The dash-dotted line (“rec mean”) in FIG. 8 indicates the RMSE that resulted with an approach in which the weighted mean between the current grid point value and the new sample was used for replacing the stored grid point value. Such a weight may be set in the configuration etc.

It can be seen that the approach using the geometric mean resulted in the best performance, regardless of the number of nearest neighbors considered.

It has to be noted that the results presented in FIGS. 6 to 8 are based on measurements under real conditions at a selected measurement site and that the results are not exactly reproducible.

Returning now to FIG. 4, if it is determined that the grid point is a grid point for which no data has been stored so far in the database in memory 206 (action 213), an ellipse is determined based on the co-ordinates of all grid points for which data has been stored and of the grid point to which the newly received data has been mapped. (action 231) The ellipse defines a region in which it is assumed that signals from the node are likely to be received, while the area outside of the ellipse defines a region in which it is assumed that signals from the node are less likely to be received. By setting the size of the ellipse, it is determined whether the measurement result for the node has higher or lower chances of being accepted as actually being based on signals from the node.

If the new grid point lies within the determined ellipse (action 232), the received Rx level value is stored with reference to this grid point. (action 233)

It is to be understood that in another embodiment, another type of area than an ellipse could be used as well. It is further to be understood that in another embodiment, the area could be determined based only on the co-ordinates of all grid points for which data has been stored so far.

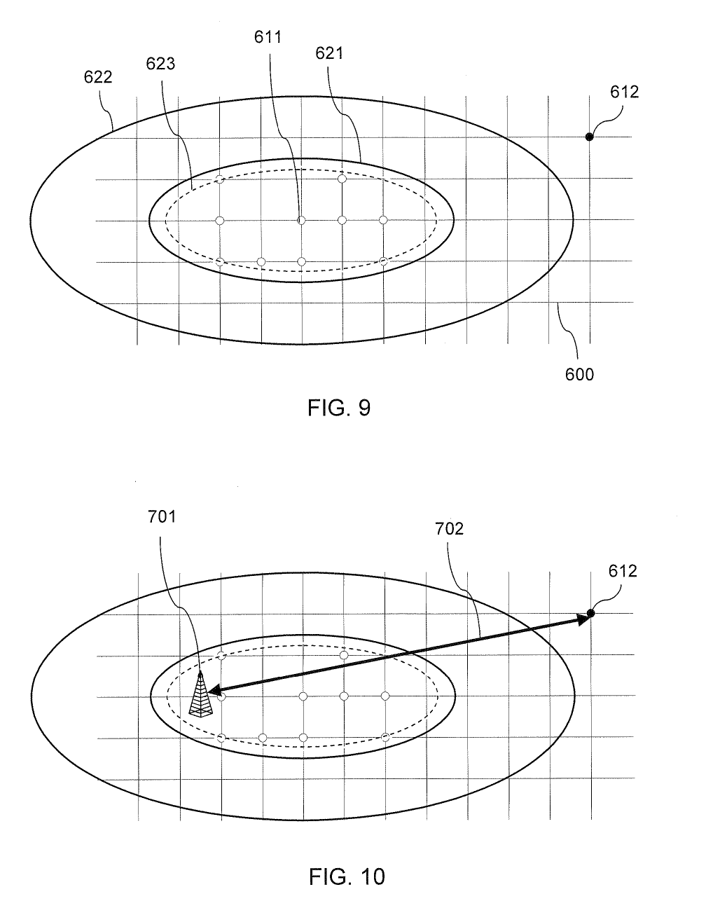

The possible use of a confidence ellipse as the ellipse of action 231 is illustrated in FIG. 9. FIG. 9 is a diagram showing a grid. Data has been stored with a mapping to exemplary grid points of this grid. These grid points are marked with small white circles 611. In addition, a grid point to which the newly received data may have been mapped in action 212 is marked with a small black circle 612.

A first ellipse 621 represents a 1-sigma covariance ellipse that has been calculated based on all the sample coordinates 611, 612. The 1-sigma covariance ellipse covers one standard deviation of the grid points with associated data from the mean of the grid points with associated data. Now, it is possible to perform a Chi-squared test with 2 degrees-of-freedom to the sample points. Setting the desired confidence for instance to 95%, the inverse Chi-squared cumulative distribution function (CDF) may be used for determining a rejection range for the new grid point, resulting in that grid points outside a 2.45-sigma ellipse are considered as outliers at 95% confidence.

The calculation for determining whether a grid point is an outlier may be for example as follows: X is an N-by-2 matrix of the N grid point locations with associated data. Each row of the matrix represents one grid point. The first column comprises the respective first co-ordinate of the grid point, and the second column comprises the respective second co-ordinate of the grid point. For each column of X the mean value is calculated, resulting in a 1-by-2 matrix, or row vector, μ. Next, the covariance matrix C is calculated as

C=(X−M)^{T}·(X−M)/(N−1),

where M is an N-by-2 matrix with row vector μ repeating in each row of matrix M.

The shape matrix A of the ellipse is the inverse of C, that is, C⁻¹. Now the condition for a grid point with co-ordinates that are written as entries of a 1-by-2 matrix x to be an outlier is D>2.45 (95% confidence) with

D=\sqrt{(x−μ)·A·(x−μ)^{T}}.

The 2.45-sigma ellipse is represented in FIG. 9 as a second ellipse 622. It can be seen that the new sample mapped to grid point 612 is an outlier at 95% confidence. Thus the grid point may be discarded based on the distance analysis. Having discarded the outlier grid point 612, a third ellipse 613 denoting the 1-sigma covariance ellipse for the stored data may be obtained. This ellipse 613 represents the coverage area of the node that may be used for instance in a positioning phase.

However, if the new grid point does not lie within the determined ellipse (action 232), a further evaluation may be performed before finally discarding the newly received Rx level value, in case the position of the node and a radio channel model defining the pathloss for the node are available. It is to be understood that the radio channel model for a node may also be computed specifically for this further evaluation based on the currently stored data for the node and, optionally, the newly received data for the node.

Based on the distance between the known position of the node and the location represented by the new grid point on the one hand and on the radio channel model on the other hand, the expected Rx level value and its variance at the location represented by the new grid point can be determined. (action 234) It is to be understood that in case an area is served by a directional antenna of a node, the radio channel model may also take account of the direction of transmission.

The use of a radio channel model is illustrated in FIG. 10. FIG. 10 is a diagram presenting the same elements as FIG. 9. In addition, a node 701 is shown at a known position, and the distance between the node 701 and the location represented by the grid point 612 to which the newly received sample has been mapped is indicated by a double-headed arrow 702.

If the received Rx level value is close to the expected Rx level value, that is, if it lies within a range defined by the expected Rx level value and its variance (action 235), the received Rx level value and any other data provided for the same position and node may be stored with a mapping to the determined grid point. (action 233)

In contrast, if the received Rx level value is not close to the expected Rx level value, that is, if it does not lie within a range defined by the expected Rx level value and its variance (action 235), the received Rx level value and other data provided for the same position may finally be discarded, at least for the purpose of updating the database. (action 236)

In case it is determined to store the received Rx level information, though, the previously stored data may optionally be re-evaluated in addition before or after action 233. (action 237) To this end, it may be determined for each grid point to which data had been mapped at an earlier stage, whether it lies in the 2.45-sigma covariance ellipse determined in action 231. For all grid points lying within the ellipse, the re-evaluation is completed. For all other grid points, furthermore an expected range of Rx level values may be determined based on the radio channel model. In this case, the used radio channel model should be based as well on data in the newly received message. All Rx level values that deviate significantly from the expected range of Rx level values at the respectively relevant grid point are deleted along with all other data that are stored for this grid point.

Thus, there may be situations in which the newly received data is accepted, but previously stored data is removed again, because the newly received data makes a grid point, for which data had previously been stored, appear to be an outlier. It is to be understood that in this re-evaluation, all grid points to which stored data is mapped could be considered, or only a subset of these grid points. Such a subset could comprise for instance only grid points in the outer regions of the grid.

The re-evaluation could also be performed irrespective of whether the newly received Rx level has been accepted for storage. In this case, the re-evaluation of stored data could also be performed in parallel to actions 231-236. However, re-evaluating stored data only when it has been determined to accept newly received Rx level information may have the effect that extreme new outliers are not enabled to cause an inappropriate removal of old data.

The data stored in memory 206 may be used for regularly updating further models, for example radio channel models, or for supporting a positioning of mobile terminals directly.

Summarized, the operation presented with reference to FIG. 4 shows that different approaches can be used for evaluating incoming samples with respect to previously stored information in order to limit number of the grid data updates, while simultaneously keeping up or even improving the quality of the stored data and thus, for instance, of the performance of a positioning making use of the stored data.

It has to be understood that the different approaches as presented with reference to actions 221 and 222, actions 231 and 232, and actions 234 and 235 can be implemented in combination, as for the operation of FIG. 4. Alternatively, only any one or any two of the approaches could be implemented by itself in an apparatus.

It has further to be noted that also mobile terminals with GNSS capability may benefit from using cellular/non-cellular positioning technologies, in order to accelerate the time-to-first-fix, using the obtained location as reference location, or in order to reduce the power consumption. Furthermore, not all applications require a GNSS based position. Furthermore, positioning technologies that are based on terrestrial radio signals may be better suited to work indoors than positioning technologies that are based on satellite signals.

Furthermore, it has to be understood that also a mobile terminal might benefit from an implementation limiting the number of updates of grid data. For instance, a mobile terminal could be configured to collect a large number of samples for various nodes before providing the data to a server. In the meantime, the mobile terminal could collect and update data in a similar manner as described with reference to FIG. 4 for server 200.

Certain embodiments of the invention may thus have the effect of enabling an efficient update of data that is stored with a mapping to grid point of a grid.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)
(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Any of the memories mentioned in this text could be implemented as a single memory or as a combination of a plurality of distinct memories, and may comprise for example a read-only memory, a random access memory, a flash memory or a hard disc drive memory etc.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The functions illustrated by processor 101 or 201 in combination with memory 102 or 202, respectively, or the integrated circuit 205 can also be viewed as means for receiving information including data for a node of a communication network and an indication of a location for which the data is valid; means for evaluating the received information in view of information that is stored for the node, the stored information including data for the node and an indication of a mapping of the data to grid points of a grid, and each grid point representing a particular location; and means for determining, in response to the evaluation, whether to use the received information for updating the stored information.

The program codes in memory 102 and 202, respectively, can also be viewed as comprising such means in the form of functional modules.

FIGS. 2 and 4 may also be understood to represent exemplary functional blocks of a computer program code for supporting an efficient update of measurement results.

It will be understood that all presented embodiments are only exemplary, and that any feature presented for a particular exemplary embodiment may be used with any aspect of the invention on its own or in combination with any feature presented for the same or another particular exemplary embodiment and/or in combination with any other feature not mentioned. It will further be understood that any feature presented for an exemplary embodiment in a particular category may also be used in a corresponding manner in an exemplary embodiment of any other category.

1-28. (canceled)

29. A method comprising at an apparatus:
receiving information including data for a node of a communication network and an indication of a location for which the data is valid;
evaluating the received information at least in view of information that is stored for the node, the stored information including at least data for the node and an indication of a mapping of the data to grid points of a grid, and each grid point representing a particular location; and
determining, in response to the evaluation, whether to use the received information for updating the stored information.

30. The method according to claim 29, wherein the received data comprise at least one of:
results of measurements on signals of the node; and
a received signal strength of signals of the node.

31. The method according to claim 29, wherein evaluating the received information comprises mapping the received data to a grid point of the grid taking account of the received indication of the position, and determining a difference between a value that is based on received data mapped to the grid point of the grid and a value that is based on stored data mapped to the same grid point of the grid; and wherein it is determined to update the stored information using the received information in the case that the determined difference exceeds a threshold value.

32. The method according to claim 31, wherein the value that is based on received data mapped to the grid point of the grid is a geometric mean of received data mapped to the grid point of the grid and of stored data mapped to the same grid point of the grid.

33. The method according to claim 31, further comprising replacing stored data mapped to the grid point of the grid with a geometric mean of received data mapped to the grid point of the grid and of stored data mapped to the same grid point of the grid, in case it is determined to update the stored information using the received information.

34. The method according to claim 29, wherein evaluating the received information comprises mapping the received data to a grid point of the grid taking account of the received indication of the position, determining a region based at least on information stored for the node, and determining whether the grid point to which the received data has been mapped lies within the region; and wherein it is determined to update the stored information using the received information in the case that the grid point to which the received data has been mapped lies within the region.

35. The method according to claim 29, the method comprising:
determining a region based on the information stored for the node and on the received information; and
determining whether the stored information comprises data that is mapped to a grid point lying outside of the region, and using the result of the determination as at least one criterion for determining whether to remove data from the stored information.

36. The method according to claim 34, wherein the region is determined one of:
as a confidence region, based at least on the grid points of the grid to which stored data for the node is mapped;
as a confidence region, using a predetermined confidence that data mapped to grid points lying outside of the confidence area are outliers;
as a confidence region, using a Chi-squared test; and
as an ellipse.

37. An apparatus comprising at least one processor and at least one memory including computer program code, the at least one memory and the computer program code configured to, with the at least one processor, cause an apparatus at least to perform:
receive information including data for a node of a communication network and an indication of a location for which the data is valid;
evaluate the received information at least in view of information that is stored for the node, the stored information including at least data for the node and an indication of a mapping of the data to grid points of a grid, and each grid point representing a particular location; and
determine, in response to the evaluation, whether to use the received information for updating the stored information.

38. The apparatus according to claim 37, wherein the received data comprise at least one of:
results of measurements on signals of the node; and
a received signal strength of signals of the node.

39. The apparatus according to claim 37, wherein the computer program code is configured to, with the at least one processor, cause an apparatus to:
evaluate the received information by mapping the received data to a grid point of the grid taking account of the received indication of the position, and by determining a difference between a value that is based on received data mapped to the grid point of the grid and a value that is based on stored data mapped to the same grid point of the grid; and
determine to update the stored information using the received information in the case that the determined difference exceeds a threshold value.

40. The apparatus according to claim 39, wherein the value that is based on received data mapped to the grid point of the grid is a geometric mean of received data mapped to the grid point of the grid and of stored data mapped to the same grid point of the grid.

41. The apparatus according to claim 39, wherein the computer program code is further configured to, with the at least one processor, cause an apparatus to replace stored data mapped to the grid point of the grid with a geometric mean of received data mapped to the grid point of the grid and of stored data mapped to the same grid point of the grid, in case it is determined to update the stored information using the received information.

42. The apparatus according to claim 37, wherein the computer program code is configured to, with the at least one processor, cause an apparatus to:
evaluate the received information by mapping the received data to a grid point of the grid taking account of the received indication of the position, by determining a region based at least on information stored for the node, and by determining whether the grid point to which the received data has been mapped lies within the region; and
determine to update the stored information using the received information in the case that the grid point to which the received data has been mapped lies within the region.

43. The apparatus according to claim 37, wherein the computer program code is configured to, with the at least one processor, cause an apparatus to:
determine a region based on the information stored for the node and on the received information; and
determine whether the stored information comprises data that is mapped to a grid point lying outside of the region, and use the result of the determination as at least one criterion for determining whether to remove data from the stored information.

44. The apparatus according to claim 42, wherein the computer program code is configured to, with the at least one processor, cause an apparatus to determine the region one of:
as a confidence region, based at least on the grid points of the grid to which stored data for the node is mapped;
as a confidence region, using a predetermined confidence that data mapped to grid points lying outside of the confidence area are outliers;
as a confidence region, using a Chi-squared test; and
as an ellipse.

45. The apparatus according to claim 37, wherein the received data comprise a result of measurements on signals of the node and wherein the computer program code is further configured to, with the at least one processor, cause an apparatus to:
evaluate the received information by determining a radio channel model for the node based at least on the stored information for the node, by determining at least one measurement result that can be expected at the indicated position based on the radio channel model, and by determining whether the received measurement result corresponds to one of the at least one determined expected measurement result and a range defined by the at least one determined expected measurement result; and
determine to update the stored information using the received information in the case that the received measurement result corresponds to one of the at least one determined expected measurement result and a range defined by the at least one determined expected measurement result.

46. The apparatus according to claim 37, wherein the received data comprise a result of measurements on signals of the node and wherein the computer program code is configured to, with the at least one processor, cause an apparatus to:
determine at least one measurement result that can be expected at the indicated position based on a radio channel model for the node;
determine whether the received measurement result corresponds to one of the at least one determined expected measurement result and a range defined by the at least one determined expected measurement result; and
determine to update the stored information using the received information in the case that the received measurement result corresponds to one of the at least one determined expected measurement result and a range defined by the at least one determined expected measurement result.

47. The apparatus according to claim 37, wherein the apparatus is one of:
a server;
a component for a server;
a mobile terminal; and
a component for a mobile terminal.

48. A non-transitory computer readable storage medium in which computer program code is stored, the computer program code when executed by a processor causing an apparatus to perform the following:
receive information including data for a node of a communication network and an indication of a location for which the data is valid;
evaluate the received information at least in view of information that is stored for the node, the stored information including at least data for the node and an indication of a mapping of the data to grid points of a grid, and each grid point representing a particular location; and
determine, in response to the evaluation, whether to use the received information for updating the stored information.
